(19) United States
(12) Patent Application Publication
(10) Pub. No.: US 2026/0337996 A1
(43) Pub. Date: Oct. 29, 2026

(54) SYSTEM FOR DELIVERING ORDERS, IN PARTICULAR A DRIVE-THROUGH, AND METHOD USED IN SUCH A SYSTEM

(71) Applicant: EXOTEC PRODUCT FRANCE, Wasquehal (FR)

(72) Inventor: Romain MOULIN, Lille (FR)

(21) Appl. No.: 19/653,372

(22) Filed: Apr. 21, 2026

(30) Foreign Application Priority Data
Apr. 25, 2025 (FR) 2504400

(51) Int. Cl. E04H 14/00; B65G 1/137; B65G 15/30; B65G 29/02; B65G 37/00; B65G 47/57; B65G 47/66

(52) U.S. Cl. CPC E04H 14/00; B65G 1/1378; B65G 15/30; B65G 29/02; B65G 37/00; B65G 47/57; B65G 47/66; B65G 2201/0258; B65G 2812/013

(57) ABSTRACT

The present disclosure relates to a system for delivering orders to a picking location located outside a storage building comprising a continuous conveyor extending from the interior of the building to said picking location, extending through an underground tunnel.

### CROSS-REFERENCE

The present application claims priority to French Patent Application No. 2504400, filed Apr. 25, 2025, the entirety of which is incorporated by reference.

The present disclosure relates to a system for delivering orders to a picking location outside a storage building. The system comprises a continuous conveyor extending from the interior of the building to said picking location.

The present disclosure further relates to a method for delivering orders used in a system.

### TECHNICAL FIELD

The present disclosure relates to the field of order delivery systems, that is logistics installations and equipment finding an application in the retail sector, more particularly in a “drive-through”; the drive-through is a service allowing a consumer or customer to be served while remaining inside, or at least close to, their car.

Such an order delivery system has a storage building inside which articles are stored, a set of parking spaces for customers adjacent to the storage building, and traffic lanes for motor vehicles, typically one or more access lanes to the parking spaces allowing access to the spaces for collecting the orders, and one or more lanes allowing said vehicles to vacate the parking spaces once the orders have been picked.

As a result, the parking spaces are conventionally located at a distance from the storage building, with at least one intermediate traffic lane extending between the parking spaces and the storage building. This configuration, although functional, introduces several constraints: it lengthens the time needed to get orders to customers, increases the complexity of logistics flows, and exposes operators to the risks associated with the frequent crossing of vehicle traffic lanes.

In such an order delivery system, operators move back and forth between the storage building and the parking spaces, pushing carts filled with articles from the various orders, to deliver said articles to the parked vehicle. Each round trip requires operators to cross the intermediate traffic lane, which is not ideal from the point of view of logistical fluidity. This not only results in loss of time and increased physical fatigue for the operators, but also in the risk of accidents, notably in dense traffic or poor visibility. This also limits the rate at which orders can be picked and delivered, and therefore the overall capacity of the site.

### PRIOR ART

However, it is known from the present applicant, in particular from document FR3.100.237A1, a system for automatically delivering orders to a picking location outside a building, comprising a transport module mounted at height, having a track and suspension members such as hooks movable along said track. These hooks can be configured to suspend pouches adapted to receive a bag of articles, as disclosed by FR3.100.237A1.

The pouches (or bags of articles) are moved automatically from the interior of the building containing the articles for order picking to the picking location, via a tunnel enveloping a portion of the track extending outside the building, above a traffic lane for motor vehicles.

Such an automated conveying solution represents a significant advance with respect to the state of the art, which requires incessant manual movement. It improves ergonomics for operators, reduces the risks of accidents, speeds up logistics flows, and thus improves the overall efficiency of the order delivery service.

However, according to the inventor's findings, such an automated order delivery system is not free from significant defects. In particular, the integration of an external tunnel overhanging the traffic lane poses several major problems. On the one hand, its construction is technically complex: it requires heavy infrastructure, greater precision in laying the track and suspension members, and high construction costs. On the other hand, setting up such tunnels often comes up against regulatory obstacles: obtaining administrative authorizations, notably building permits, can prove difficult, if not impossible, depending on the local jurisdiction. This process can lead to significant delays, increase project costs, and compromise the profitability of the installation. Furthermore, the addition of overhead structures above traffic lanes can raise public safety concerns and complicate site insurance.

### SUMMARY

This disclosure improves the situation.

A system for delivering orders to a picking location situated outside a storage building is proposed, comprising a continuous conveyor extending from the interior of the building to said picking location.

According to the present disclosure, said continuous conveyor has:
at least one transmission loop,
at least one article carrier driven by said at least one transmission loop, and wherein an underground tunnel extends from the interior of the storage building to the exterior of the building through:
an inner shaft opening into the interior of the building, through which extends a first end section of the continuous conveyor forming a descender which exits into the interior of the building,
an outer shaft to the exterior of the building opening out at said picking location through which extends a second end section of the continuous conveyor forming an elevator which exits to the exterior of the building at said picking location,
an intermediate, underground passageway extending at least along a horizontal component connecting the inner shaft and the outer shaft, through which extends an intermediate section of the continuous conveyor configured for the horizontal transport of said at least one article carrier from the descender to said elevator and wherein the continuous conveyor has a mechanism for controlling the orientation of said at least one article carrier with respect to said at least one transmission loop, comprising a rotation axis between said at least one article carrier and the transmission loop, configured to maintain a carrier surface in a horizontal orientation.

The features disclosed in the following paragraphs can optionally be implemented independently of one another or in combination with one another:

According to one embodiment, the control mechanism of said at least one carrier with respect to said at least one transmission loop may have
a cam system having several cams extending along the different sections of the continuous conveyor consisting of the first end section, the intermediate section and the second end section of the continuous conveyor,
a cam follower system belonging to said at least one article carrier configured to engage with said cams as said at least one article carrier travels along the different sections of the continuous conveyor consisting of the first end, the intermediate section and the second end section.

According to one embodiment, the cam follower system has:
a) a first pair of guide wheels, oriented in a first horizontal direction, and
b) a second pair of guide wheels oriented in a vertical direction and wherein the cam system has:
c) first guides having rectilinear horizontal guides extending lengthwise along the intermediate section of the continuous conveyor, the horizontal guides configured to cooperate with the guide wheels of the first pair to ensure the horizontal orientation of said at least one support as it travels through the intermediate section of the continuous conveyor
d) second guides having rectilinear vertical guides extending lengthwise along the height along the first end section and along the second end section configured to cooperate with the wheels of the second pair to ensure the horizontal orientation of said at least one article carrier as it travels down the inner shaft, and as it travels up the outer shaft.

In particular, the first guides and/or the second guides have curved guides arranged at the transition zones of said at least one transmission loop between:
the first end section forming the descender, on the one hand, and the intermediate section of the continuous conveyor,
the intermediate section of said continuous conveyor, on the one hand, and the second end section forming said elevator, the curved guides configured to ensure a transition of the guidance between:
a first configuration by the cooperation of the first pair of guide wheels and the first guides during the horizontal travel of said at least one support
a second configuration by the cooperation of the second pair of guide wheels and the second guides during the vertical travel of said at least one article carrier.

According to one embodiment, the article carrier has an article carrier surface for a storage unit, said carrier surface arranged below the level of the rotation axis, the portion of the carrier forming the carrier surface being connected to the rotation axis via at least one vertical component connection of said carrier, the article carrier and storage unit assembly resting on the carrier having a center of gravity arranged below the level of the rotation axis, plumb with this latter, the control mechanism of said at least one carrier with respect to the transmission loop configured to maintain the carrier surface horizontal by the action of gravity on said article carrier and storage unit assembly.

According to one embodiment, the article carrier has a comb having several teeth parallel to one another, and wherein:
the first end section has a travel direction reversal zone before which the article carrier is driven upwards,
   a transfer system comprising a fixed comb,
   and wherein the article carrier is configured to pick articles from the fixed comb when the teeth of the article carrier pass through the teeth of the fixed comb as it rises before passing through the reversal zone.
   and/or
the second end section has a travel direction reversal zone after which the article carrier is driven downwards,
   a transfer system comprising a fixed comb,
   and wherein the article carrier is configured to deposit the articles on the fixed comb when the teeth of the article carrier pass through the teeth of the fixed comb, as it descends after passing through the reversal zone.

The order delivery system can be a vehicle collection system, or drive-through comprising one or more parking spaces arranged at said picking location.

The order delivery system can have a vehicle traffic lane in communication with the parking space(s), with the continuous conveyor running underground beneath said traffic lane.

According to one embodiment, said at least one transmission loop comprises a first loop and a second loop, which are parallel and synchronized.

According to a second aspect, the present disclosure relates to an order delivery method implementing an order delivery system according to the present disclosure comprising:
picking an order for articles in the storage building and placing the articles in one or more storage units,
depositing the storage unit(s) on said at least one article carrier, and transferring said storage unit(s) from the storage building to said external picking location by conveying said at least one article carrier driven by said at least one transmission loop which successively descends into the inner shaft, moves horizontally through the intermediate passage of the tunnel and ascends into the outer shaft.

### BRIEF DESCRIPTION OF THE DRAWINGS

Further features, details and advantages will become apparent from the detailed description below, and from an analysis of the appended drawings, wherein:

FIG. 1 is a cross-sectional view of an order delivery system according to the present disclosure, showing the storage building, an order picking location, and a continuous conveyor extending from the storage building to said picking location by passing underground under a traffic lane for a motor vehicle, the lane arranged intermediate between the storage building and said picking location, the continuous conveyor, according to one embodiment, using cams and cam followers to control the horizontal orientations of article carriers along different length sections of the conveyor consisting of:
a first end section with a descender function extending into a shaft inside the building,
an intermediate section with a horizontal component passing under the traffic lane,
and a second end section with an elevator function located outside the storage building.

FIG. 2 is a detail view of a portion of the continuous conveyor of the system of FIG. 1, showing the transition zone between two sections of the conveyor consisting of the intermediate section and the second end section of the continuous conveyor with an elevator function, as well as said at least one transmission loop which has a first loop and a second loop in parallel, guided by guide/drive pulleys or the like (for example toothed wheels) with an angle transmission function between the two sections.

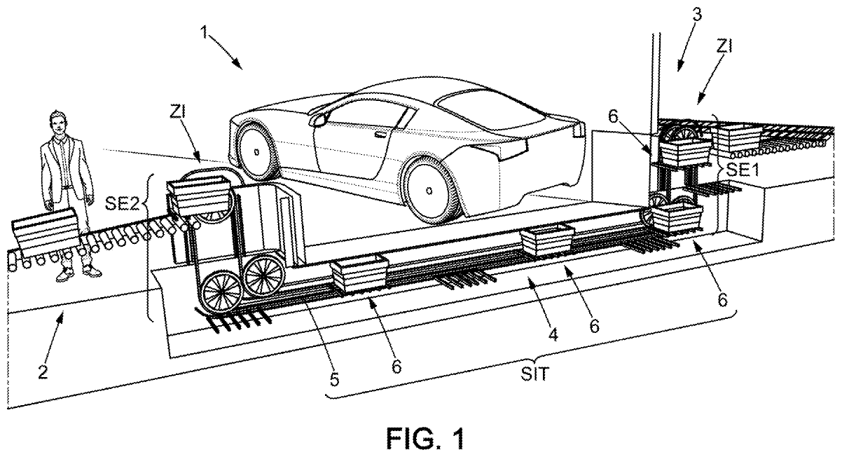

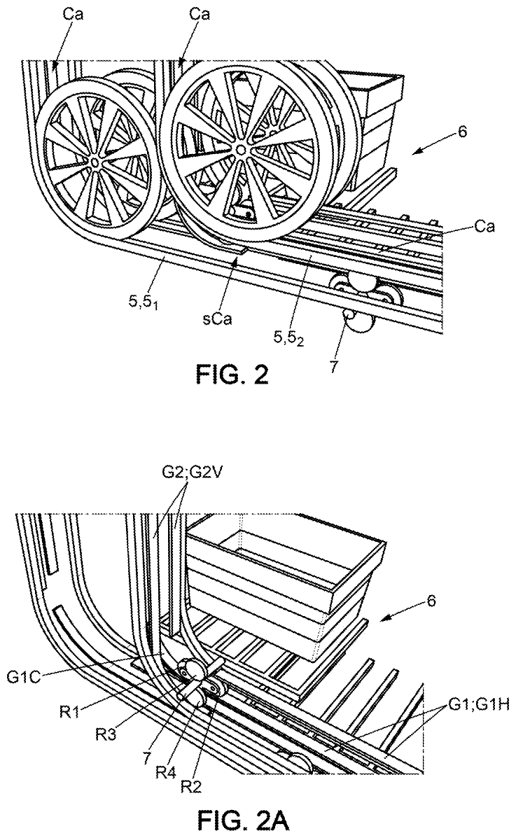

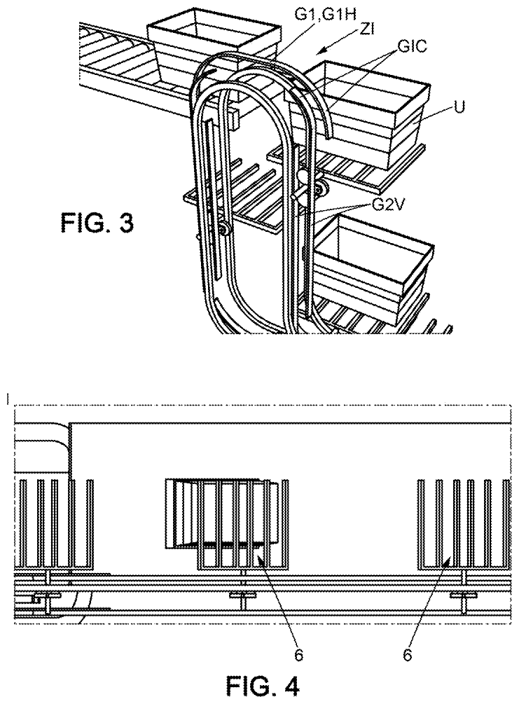

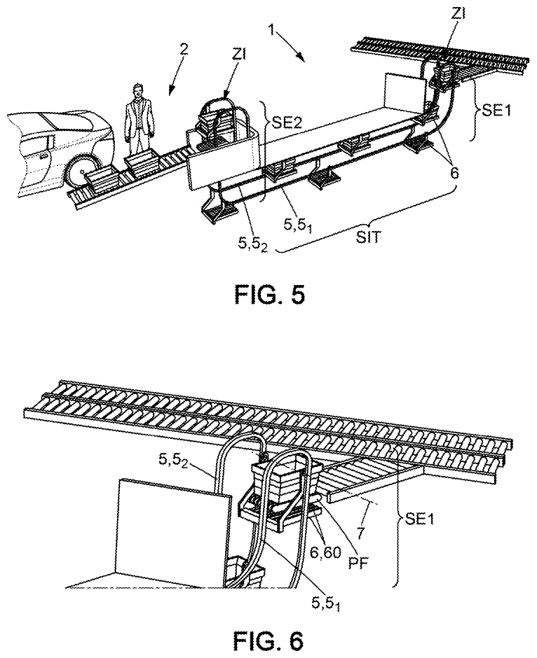

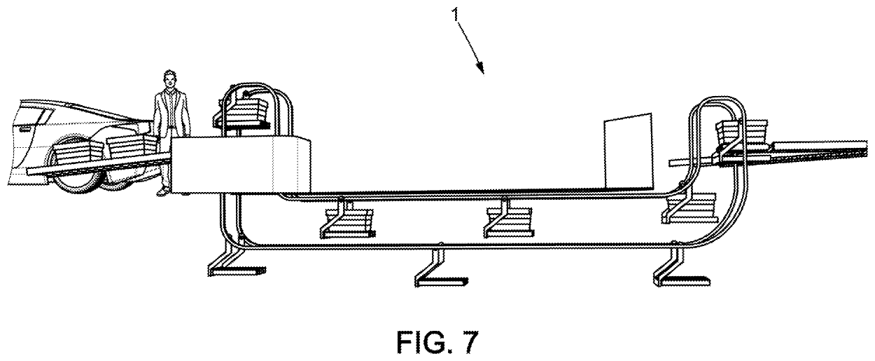

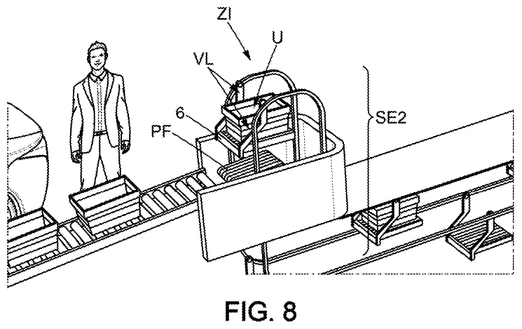

FIG. 2A is a view according to FIG. 2, with the guide wheels omitted to reveal the cam follower system which has a first pair of guide wheels, oriented horizontally and a second pair of guide wheels, oriented vertically, and wherein the cams have:
first guides having rectilinear horizontal guides extending lengthwise along the intermediate section of the continuous conveyor, the horizontal guides configured to cooperate with the guide wheels of the first pair to ensure the horizontal orientation of said at least one support as it travels through the intermediate section of the continuous conveyor
second guides having rectilinear vertical guides extending lengthwise along the height and along the second end section, configured to cooperate with the wheels of the second pair to ensure the horizontal orientation of said at least one article carrier as it ascends into the outer shaft.

FIG. 3 is a detail view of the second end section with an elevator function.

FIG. 4 is a bottom view of the intermediate section of the continuous conveyor of FIG. 1.

FIG. 5 is a perspective view (partial with the building being omitted) of an order delivery system according to a second embodiment of the present disclosure using gravity to control the horizontal orientations of the article carriers along different length sections of the conveyor, the article carriers freely articulated with respect to the transmission loop via substantially horizontal rotation axes, the article carriers configured so that the center of gravity of the carrier and storage unit assembly carried by said carrier is located below said rotation axis, plumb with this latter.

FIG. 6 is a detail view of the system according to FIG. 5, showing the first end section with a descender function, the article carrier notably having a comb whose teeth are configured to pass through the teeth of a fixed comb for transferring a storage unit, upstream of a reversal zone for which the article carrier is driven upwards, before descending into the inner shaft, after passing through the reversal zone.

FIG. 7 is a front view of the system of FIG. 5.

FIG. 8 is a detail view of the second end section, with an elevator function, of the continuous conveyor of FIG. 5, notably having a fixed comb configured to pick a storage unit from an article carrier, after passing through a travel direction reversal zone when the teeth of the comb of the article carrier pass through the teeth of the fixed comb on descent.

### DESCRIPTION OF EMBODIMENTS

The present disclosure relates to a system for delivering orders 1 to a picking location 2, said picking location being located outside a storage building 3.

The order delivery system 1 can typically be that of a drive-through, i.e. a vehicle collection system. One or more parking spaces can be arranged at said picking location to allow the parking of motor vehicles.

The parking spaces are accessible via traffic lanes, preferably including at least one access lane and one exit lane.

The storage building 3 receives the articles for orders, and may comprise shelving or other systems for storing items.

Order picking inside the building can be carried out by one or more operators collecting the articles for the order from the storage system and its racks. Alternatively, the storage building can optionally be fitted with an Automated Storage and Retrieval System (ASRS) to automate the storage and retrieval of articles for order picking. The ASRS can comprise, for example, racks, self-guided vehicles and at least one order picking station, the self-guided vehicles being configured to convey the articles for the order from the racks to said order picking station.

The articles for an order can be grouped together, at least in part, in a storage unit U, which can be a container, a carton, or any other form of packaging. The storage unit U with the articles for the order can be picked in advance and be returned to the ASRS storage system, allowing it to be temporarily stored before being transported to said picking location.

The order delivery system 1 according to the present disclosure has a continuous conveyor 4 extending from the interior of the building to said picking location.

### Notably, Said Continuous Conveyor 4 Has:

at least one transmission loop 5,
at least one article carrier 6 driven by said at least one transmission loop 5.

Said at least one transmission loop 5 may have a single loop (not shown), or else several loops arranged in parallel with each other, and in particular two loops consisting of a first loop 5₁ and a second loop 5₂, and as shown in FIGS. 1 to 8. When said at least one transmission loop 5 has several loops, said at least one carrier 6 is typically simultaneously integral with the different loops, and in particular with the two loops 5₁, 5₂.

Said at least one loop 5, (and if necessary each of the transmission loops) is guided by several guide pulleys (or toothed wheels), at least one of the pulleys being driven by a motor, typically an electric gear motor, to ensure the movement of the transmission loop, and therefore of said at least one article carrier 6 integral with the loop.

Said at least one article carrier 6 can be a single article carrier 6, or preferably have several article carriers 6 integral with the transmission loop 5, at several positions along said at least one transmission loop 5. The article carriers 6 can typically be distributed evenly along the length of said at least one transmission loop 5.

The article carrier 6 (or each article carrier 6) can be arranged laterally to said at least one loop 5, in particular to the first loop 5₁ and the second loop 5₂ integral with the two loops (see FIG. 1) or the article carrier 6 can be arranged in an intermediate space between the two loops 5₁, 5₂ (see FIG. 5).

Typically, the transmission loop 5 or each of the transmission loops 5₁, 5₂ can be formed by a roller chain, or else by a typically toothed belt. The chain has a set of links articulated to each other, and in such a case the guide pulleys are toothed wheels, the teeth of the wheels configured to mesh with the rollers of the links.

The article carrier 6 has a carrier surface Ss for the articles, and more particularly for the storage unit U. Typically, the article carrier 6 can convey the articles grouped together in said storage unit, or else the article carrier 6 can convey at least one article directly, without packaging, or else in a primary package.

The order delivery system 1 has an underground tunnel that extends from the interior of the storage building 3 to the exterior of the building therethrough.

The underground tunnel has:
an inner shaft opening into the interior of the building, through which extends a first end section SE1 of the continuous conveyor forming a descender which exits into the interior of the building, via a first end of the conveyor forming a (first) reversal zone ZI of the direction of travel
an outer shaft to the exterior of the building opening out at said picking location through which extends a second end section SE2 of the continuous conveyor forming an elevator which exits to the exterior of the building at said picking location 2, via a second end of the conveyor forming a (second) reversal zone ZI of the direction of travel,
an intermediate underground passage, extending at least along a horizontal component connecting the inner shaft and the outer shaft, through which extends an intermediate section SIT of the continuous conveyor configured for the horizontal transport of said at least one article carrier 6 from the first end section SE1 with a descender function to the second end SE2 with an elevator function.

Said at least one transmission loop 5 is guided at the (first) travel direction reversal zone to said second travel direction reversal zone by at least two guide pulleys (or at least two toothed wheels) forming an upper strand and a lower strand of the loop.

When said at least one transmission loop 5 is rotated, said at least one article carrier 6 is driven by said at least one transmission loop 5 which operates, for example along an upper strand of the loop, along a first direction of movement, known as the outward direction, a movement from the first end, comprising successively, a descent into the inner shaft, a horizontal movement through the intermediate passage of the tunnel, and an ascent into the outer shaft, and in order to allow the conveying of article(s) alone or articles contained in a storage unit, from the storage building to said picking location.

Once it has passed through the second travel direction reversal zone ZI at the second end section SE2, said at least one article carrier 6 is driven by the transmission loop 5 in the opposite direction, known as the return direction, and performs along, for example, a lower strand of said at least one loop 5, a return movement comprising a descent into the outer shaft, a horizontal movement through the intermediate passage, and an ascent into the inner shaft, and notably as far as the first end forming the first travel direction reversal zone ZI of the first end section SE1.

The continuous conveyor has a mechanism for controlling the orientation of said at least one carrier with respect to said at least one transmission loop 5, comprising a rotation axis 7 between said at least one article carrier 6 and the transmission loop 5, the mechanism configured to maintain a carrier surface in a horizontal orientation, and in particular regardless of the position of the article carrier 6 driven by the transmission loop 5 along the various sections of the conveyor (i.e. the first end section SE1, the intermediate section SIT or the second end section SE2), at least in the outward direction, and even in the return direction. The rotation axis 7 can typically be oriented in a horizontal direction, transversely to said at least one transmission loop 5.

In the present disclosure, and typically, “horizontal” means a horizontal direction or close to horizontal + or −10°, and “vertical” means a vertical direction or close to vertical + or −10°.

According to the embodiment, notably shown in FIGS. 1 to 4, the lower strand can be brought closer to the lower strand of said loop so as to juxtapose them with each other at the intermediate section SIT of the conveyor.

This limits the vertical space requirement of the conveyor, and therefore the height dimension of the intermediate passage of the tunnel. When the article carrier 6 is substantially planar, notably formed by a comb, the rotation axis 7 can typically be arranged to pass through the plane of the article carrier. The carrier orientation control mechanism then enables said article carrier to be positioned in the horizontal, space-saving orientation, without the article carrier increasing the vertical space requirement of the continuous conveyor.

In such an advantageous configuration of limited vertical space, only the upper strand is configured to convey the storage units U such as containers, the bringing together of the upper strand and the lower strand, spaced apart by a limited distance (i.e. less than the height dimension of the storage unit), prohibiting the conveying of the storage unit by the lower strand, and as can be understood from FIG. 1.

According to another embodiment, the upper strand and the lower strand of the transmission loop 5 can be spaced apart to allow, at least in a second operating mode, article carriers to be conveyed in the return direction, as shown for example, in the embodiment of FIG. 5 et seq.

Optionally, and according to another embodiment (not shown), the lower strand of the loop can drive said at least one article carrier, in a return direction, or even an outward direction.

The guide pulleys (or notably toothed wheels), which have a guiding and angle transmission function, are arranged:
at the travel direction reversal zones ZI at the ends of the conveyor on the first end section SE1 and the second end section SE2, but also
at the transition zone between the first end section SE1 and the intermediate section SIT of the continuous conveyor, and in particular one or more pulleys for guiding the upper strand of the loop and one or more guide pulleys intended for guiding the lower strand of the transmission loop, and also
in the transition zone between the intermediate section SIT and the second end section SE2, and in particular one or more pulleys for guiding the upper strand of the loop and one or more guide pulleys intended for guiding the lower strand of the transmission loop.

According to one embodiment, the mechanism for controlling the orientation of said at least one carrier with respect to said at least one transmission loop has
a cam system Ca having several cams extending along the different sections of the continuous conveyor consisting of the first end section SE1, the intermediate section SIT and the second end section SE2 of the continuous conveyor,
a cam follower system sCa belonging to said at least one article carrier 6 configured to engage with said cams Ca as said at least one article carrier travels along the different sections of the continuous conveyor consisting of the first end section SE1, the intermediate section SIT and the second end section SE2.

Such an embodiment of the mechanism having fixed cams along the various sections of the conveyor and cam followers, is shown by way of non-limiting example in FIGS. 1 to 4.

The cam follower system sCa can have:
a) a first pair of guide wheels R1, R2, oriented in a first horizontal direction, namely a virtual axis passing through the rotation axes of the two wheels is oriented in a horizontal direction, and
b) a second pair of guide wheels R3, R4 oriented in a vertical direction, namely a virtual axis passing through the rotation axes of the two wheels is oriented in a vertical direction.

The cam system Ca has:
c) first guides G1 having rectilinear horizontal guides G1H extending lengthwise along the intermediate section SIT of the continuous conveyor 4, the horizontal guides G1H configured to simultaneously cooperate with the guide wheels R1, R2 of the first pair to ensure the horizontal orientation of said at least one article support as it travels through the intermediate section SIT of the continuous conveyor
d) second guides G2 having rectilinear vertical guides G2V extending lengthwise along the height along the first end section and along the second end section configured to simultaneously cooperate with the wheels of the second pair of guide wheels to ensure the horizontal orientation of said at least one article carrier as it travels down the inner shaft, and as it travels up the outer shaft.

Notably, the first guides G1 and/or the second guides G2 may have curved guides GIC arranged at the transition zones of said at least one transmission loop 5 between:
the first end section SE1 forming the descender, on the one hand, and the intermediate section SIT of the continuous conveyor, and
the intermediate section SIT of said continuous conveyor, on the one hand, and the second end section SE2 forming said elevator.

The curved guides GIC are configured to ensure a transition of the guidance between:
a first configuration by the cooperation of the first pair of guide wheels R1, R2 and the first guides G1 during the horizontal travel of said at least one support
a second configuration by the cooperation of the second pair of guide wheels R3, R4 and the second guides G2 during the vertical travel of said at least one article carrier 6.

As shown in FIGS. 1 to 4, the cams can also have curved guides GIC (belonging to the first guides G1 and/or to the second guides G2) at the travel direction reversal zone ZI of the first end section SE1 and of the second end section SE2 to ensure a transition of the guidance between:
a first configuration by the cooperation of the second pair of guide wheels R3, R4 and the second guide G2 during the vertical travel of said at least one carrier (outward direction)
a second configuration by the cooperation of the first pair of guide wheels R1, R2 and the first guide G1 as said at least one article carrier 6 travels along at least one horizontal component,
a third configuration by the cooperation of the second pair of guide wheels R3, R4 and the second guide G2 during the vertical travel of said at least one carrier (return direction).

According to an embodiment shown by way of a non-limiting example in FIGS. 5 to 8, the mechanism for controlling the orientation of the article carrier with respect to said at least one transmission loop 5 uses mainly or solely gravity to ensure the orientation of said article carrier 6.

The article carrier 6 having the article carrier surface for a storage unit U, said carrier surface being arranged below the level of the rotation axis 7, the portion of the carrier forming the carrier surface being connected to the rotation axis via at least one vertical component connection LV of said carrier. According to one embodiment shown by way of example in FIG. 5, the article carrier may comprise a first vertical connection and a second vertical connection, each connecting the carrier surface to said hinge pin 7, on both sides of the carrier surface, the first vertical connection hinged to the first loop 5₁ and the second vertical connection hinged to the second loop 5₂.

The storage unit U resting on the carrier surface can be interposed between the first vertical connection and the second vertical connection.

The assembly of the article carrier 6 and storage unit U (in particular filled with articles) resting on the carrier is configured to present a center of gravity arranged below the level of the rotation axis 7, substantially plumb with this latter, the control mechanism of said at least one carrier with respect to the transmission loop configured to maintain the carrier surface horizontally by the action of gravity on said article carrier and storage unit assembly. In such an embodiment, the position of the rotation axis 7 with respect to the carrier surface is determined to balance the carrier support 6 by maintaining the horizontality of the carrier surface: the projection of the rotation axis 7 in a direction perpendicular to the carrier surface can intersect the carrier surface substantially in its middle. The height of the storage unit is preferably less than the distance between the rotation axis 7 and the carrier surface of the article carrier 6, which is formed by a comb according to the embodiment of FIGS. 5 to 8.

Typically, the order delivery system can have the vehicle traffic lane, communicating with the parking space(s), which can be an access lane to the parking space(s), or an exit lane, the continuous conveyor passing underground under said traffic lane.

According to one embodiment, said at least one article carrier 6 may be a comb having a plurality of teeth 60 parallel to each other and the order delivery system may comprise at least one transfer system having at least one fixed comb, associated with the first end section SE1 and/or with the second end section SE2.

As the first end section SE1 has the (first) travel direction reversal zone ZI before which the article carrier is driven upwards, the transfer system associated with this end has a (first) fixed comb PF,

The article carrier 6 is configured to pick articles from the fixed comb PF when the teeth of the article carrier pass through the teeth of the fixed comb, as it rises before passing through the first reversal zone ZI, and as shown in the direction of the arrow in FIG. 6. The fixed comb can be fed into the storage unit by one or more extended conveyors such as for example roller conveyors.

The second end section SE2 has the (second) travel direction reversal zone ZI after which said at least one article carrier 6 is driven downwards. The transfer system associated with this second end comprises a (second) fixed comb PF. The article carrier 6 is configured to deposit the articles on the fixed comb when the teeth of the article carrier pass through the teeth of the fixed comb, as it descends after passing through the reversal zone ZI, and as shown for example in FIG. 8.

The fixed comb can be extended by a conveyor, for example a roller conveyor, notably with an accumulation function;

Typically, the fixed combs PF can comprise a continuous motorized conveyor belt for each tooth or at least some of the teeth. The conveyor belts for the various teeth can be driven simultaneously to facilitate the loading of the first fixed comb with a storage unit U from the extension conveyor, or else to facilitate the evacuation of the storage unit resting on the second comb to the extension conveyor with an accumulation function.

The present disclosure further relates to an order delivery method implementing an order delivery system according to the present disclosure comprising:
picking an order for articles in the storage building and placing the articles in one or more storage units,
depositing the storage unit(s) on said at least one article carrier 6, and transferring said storage unit(s) from the storage building 3 to said external picking location 2 by conveying said at least one article carrier 6 driven by the transmission loop 5 which successively descends into the inner shaft, moves horizontally through the intermediate passage of the tunnel and ascends into the outer shaft.

When the first end comprises the (first) transfer system having the fixed comb PF, prior to the reversal of the travel direction of the article carrier and the lowering of the article carrier 6, the method can provide for raising the article carrier 6, which picks up the storage unit resting on the fixed comb when the comb teeth of the carrier surface pass through the teeth of the fixed comb PF.

The method may provide for the first fixed comb to be fed into said storage unit by a motorized conveyor extending from the fixed comb.

When the second end comprises the (second) transfer system having the fixed comb, the method can provide for successively raising the article carrier 6, reversing the travel direction of the article carrier which descends and depositing the storage unit when the comb teeth of the carrier surface pass through the teeth of the fixed comb PF.

The method may provide that the second fixed comb discharges said storage unit onto an extension conveyor which may be the accumulation conveyor.

When the storage building has an automated storage and retrieval system or ASRS automating the storage and retrieval of articles for order picking, having in particular, racks, self-guided vehicles and at least one order picking station, the order can be assembled at the order station by grouping together all or some of the articles for the order into one or more storage units U. The storage unit(s) thus prepared can be conveyed automatically, typically by a roller conveyor to the continuous conveyor 4, or else by one or more self-guided vehicles of the ASRS, and therefore without human intervention for transport.

### NOMENCLATURE

1. Order delivery system,
2. Picking location,
3. Storage building,
4. Continuous conveyor,
5. At least one transmission loop,
5₁, 5₂. First and second loop,
6 at least one article carrier,
60. Teeth (article carrier)
7 Rotation axis
SE1. First end section (continuous conveyor),
SE2. Second end section (continuous conveyor),
SIT. Intermediate section,
Ca, sCa. Cam system and cam follower system,
R1, R2. Guide wheels for first pair of wheels (horizontal)
R3, R4. Guide wheel for second pair of wheels (vertical)
G1, G1H. First guides and horizontal guides
G2, G2V. Second guides and vertical guides,
GIV. Curved guides,
PF. Fixed combs,
ZI. Travel direction reversal zone

1. A drive-through installation having:
a storage building inside which articles are stored,
a plurality of parking spaces arranged at a picking location outside the storage building -a vehicle traffic lane communicating with the parking spaces, the lane being arranged between the storage building and said picking location,
a plurality of storage units, such as containers or cartons,
a system for delivering orders to said picking location located outside the storage building, comprising a continuous conveyor extending from the interior of the building to said picking location, passing underground under said traffic lane,
said continuous conveyor having:
at least one transmission loop,
a plurality of article carriers integral with said at least one transmission loop, in several positions along said at least one transmission loop, driven by said at least one transmission loop, the article carriers each having a support surface on which one of the storage units can be deposited, the carrier surface configured to support a storage unit,
and wherein an underground tunnel extends from the interior of the storage building to the exterior of the building therethrough having:
an inner shaft opening into the interior of the building through which extends a first end section of the continuous conveyor forming a descender which exits into the interior of the building,
an outer shaft to the exterior of the building opening out at said picking location through which extends a second end section of the continuous conveyor forming an elevator which exits to the exterior of the building at said picking location,
an intermediate, underground passageway extending at least along a horizontal component connecting the inner shaft and the outer shaft, through which extends an intermediate section of the continuous conveyor configured for the horizontal transport of said article carriers from the descender to said elevator
and wherein the continuous conveyor has a mechanism for controlling the orientation of said article carriers with respect to said at least one transmission loop, comprising, for each article carrier, a rotation axis between said at least one article carrier and the transmission loop, configured to maintain the carrier surface in a horizontal orientation.

2. The installation according to claim 1 wherein the control mechanism of said article carriers with respect to said at least one transmission loop has
a cam system having several cams extending along the different sections of the continuous conveyor consisting of the first end section, the intermediate section and the second end section of the continuous conveyor,
a cam follower system belonging to said article carriers configured to engage with said cams as the article carriers travel along the various sections of the continuous conveyor consisting of the first end section, the intermediate section and the second end section.

3. The installation according to claim 2 wherein:
the cam follower system has:
a) a first pair of guide wheels, oriented in a first horizontal direction and
b) a second pair of guide wheels oriented in a vertical direction
the cam system having:
c) first guides having rectilinear horizontal guides extending lengthwise along the intermediate section of the continuous conveyor, the horizontal guides configured to cooperate with the guide wheels of the first pair to ensure the horizontal orientation of said article carriers as they travel through the intermediate section of the continuous conveyor
d) second guides having rectilinear vertical guides extending lengthwise along the height along the first end section and along the second end section configured to cooperate with the wheels of the second pair to ensure the horizontal orientation of said article carriers as they travel down the inner shaft, and as they travel up the outer shaft.

4. The installation according to claim 3 wherein the first guides and/or the second guides have curved guides arranged at the transition zones of said at least one transmission loop between:
the first end section forming the descender, on the one hand, and the intermediate section of the continuous conveyor,
the intermediate section of said continuous conveyor, on the one hand, and the second end section forming said elevator,
curved guides configured to ensure a transition of guidance between:
a first configuration by the cooperation of the first pair of guide wheels and the first guides during the horizontal travel of said article carriers
a second configuration by the cooperation of the second pair of guide wheels and the second guides during the vertical travel of said article carriers.

5. The installation according to claim 1, the article carriers having an article carrier surface for a storage unit, said carrier surface arranged below the level of the rotation axis, the portion of the carrier forming the carrier surface connected to the rotation axis via at least one vertical component connection of said carrier, the article carrier and storage unit assembly resting on the carrier having a center of gravity arranged below the level of the rotation axis, plumb with this latter, the control mechanism of said at least one carrier with respect to the transmission loop configured to maintain the carrier surface horizontally by the action of gravity on said article carrier and storage unit assembly.

6. The installation according to claim 1, wherein each support is a comb having a plurality of teeth parallel to one another, and wherein:
the first end section has a travel direction reversal zone before which the article carrier is driven upwards,
a transfer system comprising a fixed comb,
and wherein the article carrier is configured to pick up articles from the fixed comb when the teeth of the article carrier pass through the teeth of the fixed comb as it rises before passing through the reversal zone. and/or
the second end section has a travel direction reversal zone after which the article carrier is driven downwards,
a transfer system comprising a fixed comb
and wherein the article carrier is configured to deposit the articles on the fixed comb when the teeth of the article carrier pass through the teeth of the fixed comb, as it descends after passing through the reversal zone.

7. The installation according to claim 1, wherein said at least one transmission loop comprises a first loop and a second loop, which are parallel and synchronized.

8. An order delivery method using an installation according to claim 1 comprising:
picking an order for articles in the storage building and placing the articles in one or more storage units,
depositing the storage unit(s) on one or more of the article carriers, and transferring said storage unit(s) from the storage building to said external picking location by conveying said at least one article carrier driven by the transmission loop which successively descends into the inner shaft, moves horizontally through the intermediate passage of the tunnel and ascends into the outer shaft.
